(19) United States
(12) Patent Application Publication
(10) Pub. No.: US 2006/0108808 A1
(43) Pub. Date: May 25, 2006

(54) System and method for generating electricity using well pressures

(76) Inventor: Mervyn A.R. Chen, Winter Park, FL (US)

Correspondence Address: SCHIFF HARDIN LLP;Patent Department, 6600 Sears Tower, 233 South Wacker Drive, Chicago, IL, 60606, US

(21) Appl. No.: 10/994,771

(22) Filed: Nov. 22, 2004

(51) Int. Cl. F03B 13/00; H02P 9/04

(52) U.S. Cl. 290/54

(57) ABSTRACT

In a system and method for generating electricity, an inlet of a turbine having rotating fan blades is connected to a line from a flowing well with fluid under pressure. A nozzle is provided in front of an inlet to the turbine. An outlet from the turbine provides an exit for the fluid after the fluid drives the turbine fan blades. An electrical generator is connected to the rotating fan blades to rotate a rotor of the generator to generate electricity. The fluid exiting from the turbine may be commercially used.

### BACKGROUND

The disclosure relates to a system and method for generating electricity. It is noted and demonstrated that electricity is created when a magnet or rotor turns within a field coil or stator. This is known as a generator. In electrical power plants, these generators are turned by turbines. Some turbines are powered by wind, some by water (Hydropower), and others by stream. Power plants use turbines to turn the generators.

Wind turbines are connected to large blades that are turned by the wind force acting on them. They are usually quite small, yet suitable to generate sufficient electricity for a single household. In order to satisfy greater demands, wind farms are employed. These farms occupy large areas of land and in some case are considered to be eyesores to the landscape. Furthermore, since the wind does not blow with a constant force, fluctuations in the electricity produced are experienced.

Hydropower is achieved by constructing dams and allowing the overflowing water to turn the turbines. This is a very capital-intensive method and a large area of land is lost to flooding. Even though hydroelectric power systems can convert up to 90 percent of the available energy, its future is very uncertain. In the United States, new laws and regulations have made the licensing process extremely difficult and can take up to 10 years to obtain a license to operate a hydroelectric facility. Re-licensing for established plants is equally difficult and length. As a result, investors are unwilling to invest in such ventures.

Steam turbines are the most common, but apart from the exorbitant initial capital investment required, fuel is needed to convert water into steam for turning the turbines. This makes the operating expenses higher than the previous methods. Water is boiled in huge boilers, and the steam produced is pumped under high pressure through the turbine. As this steam hits the fan blades, it causes the turbine to turn. However, apart from the cost of purchasing fuels required to burn, the gas emitted from the burnt fuel can be hazardous to the environment.

### SUMMARY

In a system and method for generating electricity, an inlet of a turbine having rotating fan blades is connected to a line from a flowing well with fluid under pressure. A nozzle is provided in front of the inlet to the turbine. An outlet from the turbine provides an exit for the fluid after the fluid drives the turbine fan blades. An electrical generator is connected to the rotating fan blades to rotate a rotor of the generator to generate electricity.

### BRIEF DESCRIPTION OF THE DRAWINGS

FIG. 1 is a side cutaway view of the system and method for generating electricity using well pressure;

FIG. 2 is a top cutaway view of the system and method of FIG. 1;

FIG. 3 is an end view of the system and method of FIG. 1; and

FIG. 4 is a perspective side view from a side opposite that of FIG. 1.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

When wells are drilled into the earth's formation for the purpose of retrieving water or hydrocarbons, most come in flowing with pressures that can reach 5000 psi at the surface. This pressure is not used and is allowed to dissipate into the atmosphere. The disclosed embodiment of the system and method is very inexpensive to build and is designed to be attached to the production line of a flowing well. It is a simple housing that encloses a rotating fan fixed to a shaft, which is connected to a generator. Materials used are of hardened steel in order to withstand the well pressures.

When a well is drilled into the earth's formation for the purpose of retrieving water or hydrocarbons, in order for the fluid to flow to the surface, there must be sufficient well pressure to lift this fluid to the top. Some wells can develop pressures to as much as 5000 psi. on land, while off shore gas wells can reach to as much as 10,000 psi. Here, the term fluid includes gases and liquids.

A choke is installed within the tubing in order to restrict the escape of excessive pressure. This helps to prevent the depletion of the well pressure to avoid the fluid from being left back in the earth's formation without any pressure to bring it to the surface.

After the fluid is passed through scrubbers, etc., and collected in holding tanks, the pressure is allowed to phase out. It is for the purpose of using this wasted energy that this system and method is provided. No one has successfully used well pressures as a means of propulsion to generate electricity in accordance with the preferred embodiment disclosed herein.

Since these flowing wells already exist in abundance, there is no expense for drilling. No land is lost for installation, and no emissions to contaminate the atmosphere. Furthermore, this pressure is totally free so the operational expense is restricted to basic maintenance. This means cheaper electricity and greater profits.

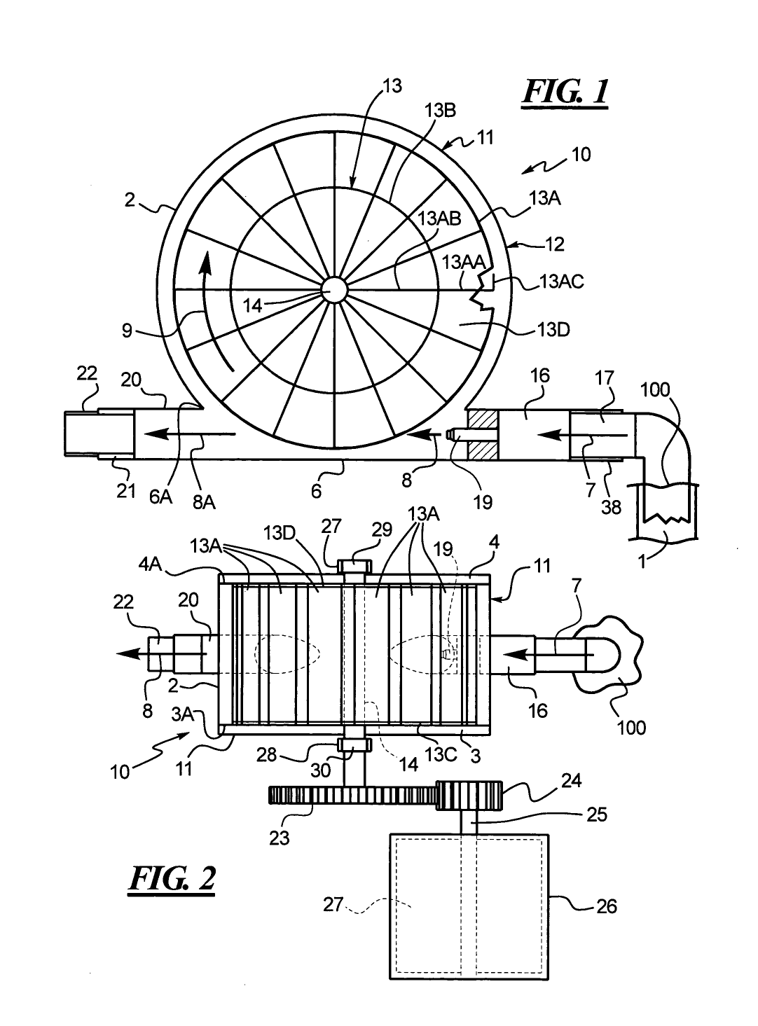

The system 10 for generating electricity using well pressures is shown in FIG. 1 in cross-section. A turbine 11 is formed of an outer casing 12 having an outer peripheral surface 2 with round side system plates 3 and 4 and corresponding gaskets 3A and 4A retained by screws 200 or the like to an inwardly extending lip 2A of peripheral surface 2 (see FIGS. 2-4 also). The casing 12 provides a fluid tight casing. A rotating drum 13 serving as a fan is provided and having an inner peripheral surface 13B and fan blades 13A formed of inner fan blade portions 13AB and outer fan blade portions 13M divided by peripheral surface 13B (see also FIGS. 2-4). The outer fan blade portions 13AA may have respective outer lips 13AC. The drum 13 also has sidewalls 13C and 13D between which the outer fan blade portions 13AA extend. These sidewalls 13C and 13D have a plurality of respective radial projections 13CC and 13DD which interact with the side system plates to substantially prevent fluid from entering the region near the central shaft 14 and prevent cavitations (see FIG. 4).

Although as shown in FIG. 1, the fan blades have a surface perpendicular to the fluid flow, the fan blade surface could be angled, such as at 45° to the direction of fluid flow.

The rotating drum 13 rotates in the rotating or turning direction 9 about a center shaft 14. At the bottom of the turbine 11, the rotating drum fan blades are impinged upon by the fluid flow 8 exiting from nozzle or choke 19 which is flowing at a higher velocity-than the velocity at the input fluid flow 7 at an inlet 16 of a production tube or line section 6 which receives an inlet well production tube or line 17 from the well 1 in ground 100. This inlet tube or line 17 may be received and secured by threading 38 by a press-fit, or by other means of attachment to the inlet 16 of production tube section 6. The nozzle or choke 19 is mounted in the inlet 16 just before the turbine 11 as illustrated. The turbine 11 is welded at a cutout 6A of the production tube section 6 such that a cutout 12A in casing 12 lines up with the cutout 6A.

An outlet 20 of production tube section 6 channels the fluid flow 8A to an outlet production tube or line 22 which may be secured such as by threads 21, a press-fit relationship, or other means of attachment.

As shown in FIG. 2, the center shaft 14 connects to a large gear 23 driving a small gear 24 connected to a shaft 25 of a generator 26 having a rotor 27 connected to shaft 25. The generator 26 creates electrical power.

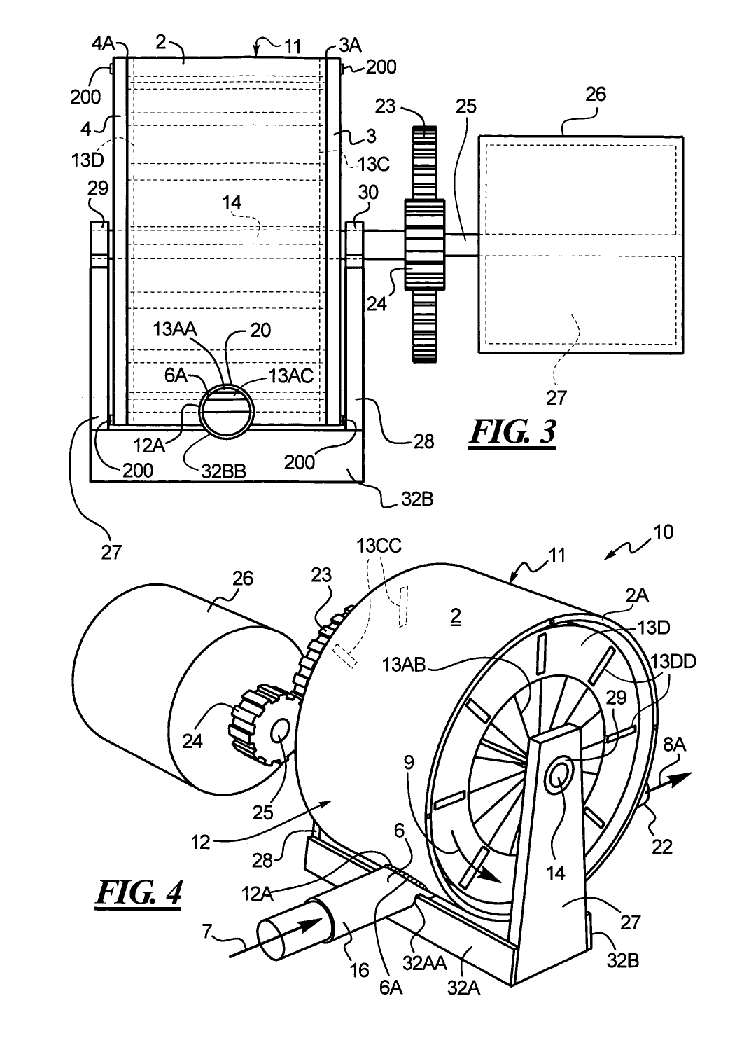

As shown most clearly in FIGS. 2, 3, and 4, the center shaft 14 of the turbine 11 rotates in respective bearing collars 29 and 30 located in respective apertures of upwardly standing support members 27 and 28. In FIG. 4, the inner portion 13AB of the fan blades can be seen since the side system plate 3 has been removed for clear viewing. Also, and in FIG. 3 a leading bent edge lip 13AC of one of the outer fan blade portions 13AA is also visible inside the tube 6.

In the preferred embodiment shown, there is preferably about a three-quarter inch gap between the end of the fan blade 13AA and the bottom of the production tube section 6 between the inlet 16 and outlet 20. In one preferred embodiment, the diameter of the production tube section 6 is about two inches.

As shown most clearly in FIGS. 3 and 4, at the bottom of upwardly standing support members 27 and 28 are entry side and exit side support plates 32A and 32B having respective notches 32AA and 32BB in which the support tube section 6 is supported and may be attached such as by welding if desired. In FIGS. 3 and 4 the cutout 6A in a production tube section 6 can also be clearly seen in which the turbine casing 12 rests. The turbine casing 12, of course, also has a corresponding cutout 12A lined up with cut 6A of the casing 6.

With the described system and method, when the well fluid flows, it is passed through the nozzle or nozzles, which increase the velocity of the fluid. This fluid under high pressure, strikes the fan blades, causing the drum comprising the hub and fan blades to turn. As a result, the attached gears turn, causing the rotor within the generator to also turn. Electricity is thus produced.

In a small version of the system, PVC may be used to make production tube section for the turbine, and a small generator is attached. A fluid pump can be used to simulate the required pressure. When the fluid is pumped through the turbine, the fan blades turn causing the generator to turn also. An electric current is provided. In a large version, as previously described, preferably hardened steel is used for the main components, including the turbine and the production tube section.

Although the production tube section and inlet and outlet tubes have been shown round, they may have other configurations.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A system for generating electricity, comprising:
a well production line section for connection to a flowing well with fluid under pressure;
the well production line section providing an inlet to a turbine having rotating fan blades;
a nozzle acting as a choke for the pressurized fluid from the well and for increasing a velocity of fluid hitting the fan blades;
an outlet from the turbine for the fluid; and
an electrical generator having a rotor connected to the turbine rotating fan blades to generate electricity.

2. A system of claim 1 wherein the well production line section comprises a tube section having an inlet and an outlet, the nozzle being mounted in a region of said tube section inlet, and said production tube section having a cutout at which the turbine is received, the turbine having an outer casing with a corresponding cutout to match the cutout of the production tube section.

3. A system of claim 2 wherein said inlet of said production tube section is connected to an inlet well production tube having one end connected to the well and the other end connected to said inlet of said production tube section.

4. A system of claim 2 wherein said outlet of said production tube section is connected to an outlet well production tube through which fluid exists after existing from the turbine.

5. A system of claim 1 wherein the fan blades are part of a rotating drum supported on a center shaft supported by respective rotational bearings mounted to support arms.

6. A system of claim 1 wherein a center shaft of the fan blades is connected to a first gear which drives a second smaller gear connected to said rotor of said generator.

7. A system of claim 1 wherein said fan blades have a planar surface perpendicular to a flow direction of the fluid from said nozzle.

8. A system of claim 1 wherein said fan blades have a surface at an angle other than perpendicular to a running direction of said fluid from said nozzle.

9. A system of claim 1 wherein the turbine and the well production line section are constructed of hardened steel.

10. A system of claim 5 wherein said rotating drum comprises radially outwardly extending fan blades having respective inner portions supporting a peripheral surface and outer portions outside of the peripheral surface, and sidewalls connected to said peripheral surface and between which the outer portions of the fan blades are provided.

11. A system of claim 10 wherein the fan blade outer portions have respective lips at right angles to the respective fan blade.

12. A system of claim 1 wherein said turbine has a casing of cylindrical shape comprising side plates and an outer peripheral surface between the side plates.

13. A system of claim 12 wherein the side plates are detachable from the outer peripheral surface, mount to a lip of the outer peripheral surface, and have projections.

14. A system for generating electricity, comprising:
a line for connecting a flowing well with fluid under pressure to a turbine having rotating fan blades;
an outlet from the turbine for the fluid; and
an electrical generator having a rotor connected to the turbine rotating fan blades to generate electricity.

15. A system of claim 14 wherein a nozzle acting as a choke for the pressurized fluid from the well and for increasing the velocity of fluid hitting the fan blades is positioned between the well and the inlet to the turbine.

16. A method for generating electricity, comprising the steps of:
providing a flowing well with fluid under pressure;
connecting an output of the well through a nozzle acting as a choke for the pressurized fluid from the well and for increasing a velocity of fluid;
directing the fluid from the nozzle to an inlet of a turbine so that the increased velocity of fluid exiting from the nozzle hits the fan blades of the turbine to turn the fan blades; and
using the turning fan blades to turn a rotor of an electrical generator to generate electricity.

17. A method of claim 16 including the step of connecting an outlet from the turbine for the fluid to a location where the fluid from the well is utilized for a commercial purpose.

18. A method of claim 16 wherein the fluid from the well comprises water.

19. A method of claim 18 wherein the water from the well after it passes through the turbine is utilized for a commercial purpose.

20. A method of claim 16 wherein the fluid from the well comprises a hydrocarbon gas.

21. A method of claim 20 wherein the hydrocarbon gas exiting from the turbine is utilized for a commercial use.

22. A method of claim 16 including the step of providing a tube section, and connecting the turbine to an opening in the tube section at an opening in the turbine.

23. A method of claim 16 including the step of connecting a shaft from the turbine to a first gear which interacts with a smaller second gear, the smaller second gear driving the rotor of the generator.

24. A method for generating electricity, comprising the steps of:
providing a flowing well with fluid under pressure;
connecting an output of the well to an inlet of a turbine, said turbine having an outlet for the fluid; and
using the turbine to turn a rotor of an electrical generator to generate electricity.
